(19) United States
(12) Patent Application Publication
(10) Pub. No.: US 2016/0203333 A1
(43) Pub. Date: Jul. 14, 2016

(54) METHOD AND APPARATUS FOR UTILITY-AWARE PRIVACY PRESERVING MAPPING AGAINST INFERENCE ATTACKS

(71) Applicant: THOMSON LICENSING, Issy Les Moulineaux (FR)

(72) Inventors: Nadia Fawaz, Santa Clara, CA (US); Abbasali Makhdoumi Kakhaki, Somerville, MA (US)

(21) Appl. No.: 14/912,639

(22) PCT Filed: Nov. 21, 2013
(86) PCT No.: PCT/US2013/071284

§ 371 Date: Feb. 18, 2016

Related U.S. Application Data
(60) Provisional application No. 61/867,543, filed on Aug. 19, 2013.

(51) Int. Cl. G06F 21/62; G06F 17/30

(52) U.S. Cl. CPC G06F 21/6245; G06F 17/30598

(57) ABSTRACT

The present principles focus on the privacy-utility tradeoff encountered by a user who wishes to release some public data (denoted by X) to an analyst, that is correlated with his private data (denoted by S), in the hope of getting some utility. The public data is distorted before its release according to a probabilistic privacy preserving mapping mechanism, which limits information leakage under utility constraints. In particular, this probabilistic privacy mechanism is modeled as a conditional distribution, P_(Y|X), where Y is the actual released data to the analyst. The present principles design utility-aware privacy preserving mapping mechanisms against inference attacks, when only partial, or no, statistical knowledge of the prior distribution, P_(S,X), is available. Specifically, using maximal correlation techniques, the present principles provide a separability result on the information leakage that leads to the design of the privacy preserving mapping.

### CROSS-REFERENCE TO RELATED APPLICATIONS

This application claims the benefit of the filing date of the following U.S. Provisional Application, which is hereby incorporated by reference in its entirety for all purposes: Ser. No. 61/867,543, filed on Aug. 19, 2013, and titled “Method and Apparatus for Utility-Aware Privacy Preserving Mapping against Inference Attacks.”

This application is related to U.S. Provisional Patent Application Ser. No. 61/691,090 filed on Aug. 20, 2012, and titled “A Framework for Privacy against Statistical Inference” (hereinafter “Fawaz”). The provisional application is expressly incorporated by reference herein in its entirety.

In addition, this application is related to the following applications: (1) Attorney Docket No. PU130121, entitled “Method and Apparatus for Utility-Aware Privacy Preserving Mapping in View of Collusion and Composition,” and (2) Attorney Docket No. PU130122, entitled “Method and Apparatus for Utility-Aware Privacy Preserving Mapping Through Additive Noise,” which are commonly assigned, incorporated by reference in their entireties, and concurrently filed herewith.

### TECHNICAL FIELD

This invention relates to a method and an apparatus for preserving privacy, and more particularly, to a method and an apparatus for generating a privacy preserving mapping mechanism without the full knowledge of the joint distribution of the private data and public data to be released.

### BACKGROUND

In the era of Big Data, the collection and mining of user data has become a fast growing and common practice by a large number of private and public institutions. For example, technology companies exploit user data to offer personalized services to their customers, government agencies rely on data to address a variety of challenges, e.g., national security, national health, budget and fund allocation, or medical institutions analyze data to discover the origins and potential cures to diseases. In some cases, the collection, the analysis, or the sharing of a user's data with third parties is performed without the user's consent or awareness. In other cases, data is released voluntarily by a user to a specific analyst, in order to get a service in return, e.g., product ratings released to get recommendations. This service, or other benefit that the user derives from allowing access to the user's data may be referred to as utility. In either case, privacy risks arise as some of the collected data may be deemed sensitive by the user, e.g., political opinion, health status, income level, or may seem harmless at first sight, e.g., product ratings, yet lead to the inference of more sensitive data with which it is correlated. The latter threat refers to an inference attack, a technique of inferring private data by exploiting its correlation with publicly released data.

### SUMMARY

The present principles provide a method for processing user data for a user, comprising the steps of: accessing the user data, which includes private data and public data, the private data corresponding to a first category of data, and the public data corresponding to a second category of data; decoupling dependencies between the first category of data and the second category of data, from dependencies between the second category of data and released data; determining a privacy preserving mapping that maps the second category of data to the released data responsive the dependencies between the second category of data and the released data; modifying the public data for the user based on the privacy preserving mapping; and releasing the modified data to at least one of a service provider and a data collecting agency as described below. The present principles also provide an apparatus for performing these steps.

The present principles also provide a method for processing user data for a user, comprising the steps of: accessing the user data, which includes private data and public data, the private data corresponding to a first category of data, and the public data corresponding to a second category of data; determining dependencies between the first category of data and the second category of data responsive to mutual information between the first category of data and the second category of data; decoupling the dependencies between the first category of data and the second category of data, from dependencies between the second category of data and released data; determining a privacy preserving mapping that maps the second category of data to the released data responsive the dependencies between the second category of data and the released data based on maximal correlation techniques; modifying the public data for the user based on the privacy preserving mapping; and releasing the modified data to at least one of a service provider and a data collecting agency as described below. The present principles also provide an apparatus for performing these steps.

The present principles also provide a computer readable storage medium having stored thereon instructions for processing user data for a user according to the methods described above.

### BRIEF DESCRIPTION OF THE DRAWINGS

FIG. 1 is a flow diagram depicting an exemplary method for preserving privacy, in accordance with an embodiment of the present principles.

FIG. 2 is a flow diagram depicting an exemplary method for preserving privacy when the joint distribution between the private data and public data is known, in accordance with an embodiment of the present principles.

FIG. 3 is a flow diagram depicting an exemplary method for preserving privacy when the joint distribution between the private data and public data is unknown and the marginal probability measure of the public data is also unknown, in accordance with an embodiment of the present principles.

FIG. 4 is a flow diagram depicting an exemplary method for preserving privacy when the joint distribution between the private data and public data is unknown but the marginal probability measure of the public data is known, in accordance with an embodiment of the present principles.

FIG. 5 is a block diagram depicting an exemplary privacy agent, in accordance with an embodiment of the present principles.

FIG. 6 is a block diagram depicting an exemplary system that has multiple privacy agents, in accordance with an embodiment of the present principles.

FIG. 7 is a pictorial example illustrating different privacy metrics, in accordance with an embodiment of the present principles.

### DETAILED DESCRIPTION

In the database and cryptography literatures from which differential privacy arose, the focus has been algorithmic. In particular, researchers have used differential privacy to design privacy preserving mechanisms for inference algorithms, transporting, and querying data. More recent works focused on the relation of differential privacy with statistical inference. It is shown that differential privacy does not guarantee a limited information leakage. Other frameworks similar to differential privacy exist such as the Pufferfish framework, which can be found in an article by D. Kifer and A. Machanavajjhala, “A rigorous and customizable framework for privacy,” in ACM PODS, 2012, which however does not focus on utility preservation.

Many approaches rely on information-theoretic techniques to model and analyze privacy-accuracy tradeoff. Most of these information-theoretic models focus mainly on collective privacy for all or subsets of the entries of a database, and provide asymptotic guarantees on the average remaining uncertainty per database entry- or equivocation per input variable after the output release. In contrast, the framework studied in the present application provides privacy in terms of bounds on the information leakage that an analyst achieves by observing the released output.

We consider the setting described in Fawaz, where a user has two kinds of data that are correlated: some data that he would like to remain private, and some non-private data that he is willing to release to an analyst and from which he may derive some utility, for example, the release of media preferences to a service provider to receive more accurate content recommendations.

The term analyst, which for example may be a part of a service provider's system, as used in the present application, refers to a receiver of the released data, who ostensibly uses the data in order to provide utility to the user. Often the analyst is a legitimate receiver of the released data. However, an analyst could also illegitimately exploit the released data and infer some information about private data of the user. This creates a tension between privacy and utility requirements. To reduce the inference threat while maintaining utility the user may release a “distorted version” of data, generated according to a conditional probabilistic mapping, called “privacy preserving mapping,” designed under a utility constraint.

In the present application, we refer to the data a user would like to remain private as “private data,” the data the user is willing to release as “public data,” and the data the user actually releases as “released data.” For example, a user may want to keep his political opinion private, and is willing to release his TV ratings with modification (for example, the user's actual rating of a program is 4, but he releases the rating as 3). In this case, the user's political opinion is considered to be private data for this user, the TV ratings are considered to be public data, and the released modified TV ratings are considered to be the released data. Note that another user may be willing to release both political opinion and TV ratings without modifications, and thus, for this other user, there is no distinction between private data, public data and released data when only political opinion and TV ratings are considered. If many people release political opinions and TV ratings, an analyst may be able to derive the correlation between political opinions and TV ratings, and thus, may be able to infer the political opinion of the user who wants to keep it private.

Regarding private data, this refers to data that the user not only indicates that it should not be publicly released, but also that he does not want it to be inferred from other data that he would release. Public data is data that the user would allow the privacy agent to release, possibly in a distorted way to prevent the inference of the private data.

In one embodiment, public data is the data that the service provider requests from the user in order to provide him with the service. The user however will distort (i.e., modify) it before releasing it to the service provider. In another embodiment, public data is the data that the user indicates as being “public” in the sense that he would not mind releasing it as long as the release takes a form that protects against inference of the private data.

As discussed above, whether a specific category of data is considered as private data or public data is based on the point of view of a specific user. For ease of notation, we call a specific category of data as private data or public data from the perspective of the current user. For example, when trying to design privacy preserving mapping for a current user who wants to keep his political opinion private, we call the political opinion as private data for both the current user and for another user who is willing to release his political opinion.

In the present principles, we use the distortion between the released data and public data as a measure of utility. When the distortion is larger, the released data is more different from the public data, and more privacy is preserved, but the utility derived from the distorted data may be lower for the user. On the other hand, when the distortion is smaller, the released data is a more accurate representation of the public data and the user may receive more utility, for example, receive more accurate content recommendations.

In one embodiment, to preserve privacy against statistical inference, we model the privacy-utility tradeoff and design the privacy preserving mapping by lo solving an optimization problem minimizing the information leakage, which is defined as mutual information between private data and released data, subject to a distortion constraint.

In Fawaz, finding the privacy preserving mapping relies on the fundamental assumption that the prior joint distribution that links private data and released data is known and can be provided as an input to the optimization problem. In practice, the true prior distribution may not be known, but rather some prior statistics may be estimated from a set of sample data that can be observed. For example, the prior joint distribution could be estimated from a set of users who do not have privacy concerns and publicly release different categories of data, that may be considered to be private or public data by the users who are concerned about their privacy. Alternatively when the private data cannot be observed, the marginal distribution of the public data to be released, or simply its second order statistics, may be estimated from a set of users who only release their public data. The statistics estimated based on this set of samples are then used to design the privacy preserving mapping mechanism that will be applied to new users, who are concerned about their privacy. In practice, there may also exist a mismatch between the estimated prior statistics and the true prior statistics, due for example to a small number of observable samples, or to the incompleteness of the observable data.

The present principles propose methods to design utility-aware privacy preserving mapping mechanisms when only partial statistical knowledge of the prior is available. More precisely, using recent information theoretic results on Maximal (Rény') correlation, we first provide a separable upper bound on the information leakage, that decouples intrinsic dependencies (that is, dependencies that are inherent to the data) between the private data and the public data to be released, from the designed dependencies (that is, dependencies that are added by design) between the public data to be released and the actual released data. Consequently, we are able to design privacy preserving mapping mechanisms with only partial prior knowledge of the public data to be released, instead of requiring full knowledge of the joint distribution of the private data and public data to be released.

In one embodiment, we characterize the privacy-utility tradeoff in terms of an optimization problem. We also give an upper bound on the probability of inferring private data by observing the released data.

To formulate the problem, the public data is denoted by a random variable X∈X with the probability distribution P_{X}. X is correlated with the private data, denoted by random variable S∈S. The correlation of S and X is defined by the joint distribution P_{S,X}. The released data, denoted by random variable Y∈y is a distorted version of X. Y is achieved via passing X through a kernel, P_{Y|X}. In the present application, the term “kernel” refers to a conditional probability that maps data X to data Y probabilistically. That is, the kernel P_{Y|X} is the privacy preserving mapping that we wish to design. Since Y is a probabilistic function of only X, in the present application, we assume S→X→Y form a Markov chain. Therefore, once we define P_{Y|X}, we have the joint distribution P_{S,X,Y}=P_{Y|X}P_{S,X} and in particular the joint distribution P_{S,Y}.

In the following, we first define the privacy notion, and then the accuracy notion.

Definition 1. Assume S→X→Y. A kernel P_{Y|X} is called ε-divergence private if the distribution P_{S,Y} resulting from the joint distribution P_{S,X,Y}=P_{Y|X}P_{S,X} satisfies

$$D ( {P}_{S , Y} ‖ {P}_{S} {P}_{Y} ) {=}^{Δ} {𝔼}_{S , Y} [ log \frac{P ( S \vert Y )}{P ( S )} ] {=}^{Δ} I ( S ; Y ) = ε H ( S ) , \qquad ( 1 )$$

where D(.) is the K-L divergence, [symbol] (.) is the expectation of a random variable, H(.) is the entropy, ε∈[0,1] is called the leakage factor, and the mutual information I(S; Y) represents the information leakage.

We say a mechanism has full privacy if ε=0. In extreme cases, ε=0 implies that, the released random variable, Y, is independent from the private random variable, S, and ε=1 implies that S is fully recoverable from Y (S is a deterministic function of Y). Note that one can assume Y is completely independent from S to have full privacy (ε=0), but, this may lead to a poor accuracy level. We define accuracy as the following.

Definition 2. Let d:X×y→ [symbol] ⁺ be a distortion measure. A kernel P_{Y|X} is called D-accurate if [symbol] [d(X, Y)]≦D.

It should be noted that any distortion metric can be used, such as the Hamming distance if X and Y are binary vectors, or the Euclidian norm if X and Y are real vectors, or even more complex metrics modeling the variation in utility that a user would derive from the release of Y instead of X. The latter could, for example, represent the difference in the quality of content recommended to the user based on the release of his distorted media preferences Y instead of his true preferences X.

There is a tradeoff between leakage factor, ε, and distortion level, D, of a privacy preserving mapping. In one embodiment, our objective is to limit the amount of private information that can be inferred, given a utility constraint. When inference is measured by information leakage between private data and released data and utility is indicated by distortion between public data and released data, the objective can be mathematically formulated as to find the probability mapping P_{Y|X} that minimizes the maximum information leakage I(S; Y) given a distortion constraint, where the maximum is taken over the uncertainty in the statistical knowledge on the distribution P_{S,X} available at the privacy agent:

min max I(S; Y), s.t. [symbol] [d(X, Y)]≦D.

The probability distribution P_{S,Y} can be obtained from the joint distribution P_{S,X,Y}=P_{Y|X}P_{S,X}=P_{Y|X}P_{S|X}P_{X}. Depending on the knowledge of the statistics, the optimization problem can be written in different ways:

(1) when the joint distribution P_{S,X} is known (no remaining uncertainty on P_{S,X}), the privacy preserving mapping P_{Y|X} is the solution to the following optimization problem:

$${min}_{{P}_{Y \vert X}} I ( S ; Y ) , s . t . 𝔼 [ d ( X , Y ) ] \leq D .$$

(2) when the marginal distribution P_{X} is known, but not the joint distribution P_{S,X}, the privacy preserving mapping P_{Y|X} is the solution to the following optimization problem:

$${min}_{{P}_{Y \vert X}} {max}_{{P}_{S \vert X}} I ( S ; Y ) , s . t . 𝔼 [ d ( X , Y ) ] \leq D .$$

(3) when neither the joint distribution P_{S,X} nor the marginal distribution P_{X} is known (full uncertainty on P_{S,X}), the privacy preserving mapping P_{Y|X} is the solution to the following optimization problem:

$${min}_{{P}_{Y \vert X}} {max}_{{P}_{S , X}} I ( S ; Y ) , s . t . 𝔼 [ d ( X , Y ) ] \leq D .$$

Problems (1) to (3) describe settings with increasing uncertainty, that is, decreasing knowledge, on the joint statistics of S and X. It should be noted that the amount of statistical knowledge available on S and X affects the amount of distortion required to meet a certain level of privacy (for example, a target leakage factor). More precisely, in any of the three problems above, the same range of leakage factors can be achieved, however for a given leakage factor, mappings obtained by solving problems with less statistical knowledge may lead to higher distortion. Similarly, if one fixes the amount of distortion allowed (D), mappings obtained in settings with less statistical knowledge may have a higher leakage factor. In summary, the more knowledge about the joint statistics of S and X is available, the better the privacy-accuracy tradeoff that can be achieved.

In the following, we discuss in further detail how to solve the optimization problem under different knowledge of statistics.

### Joint Distribution P_{S,X} is Known

For a given joint distribution P_{S,X}, the optimum privacy preserving mapping is characterized as the kernel, achieving the minimum objective of

$${min}_{{P}_{Y \vert X}} I ( S ; Y ) , s . t . 𝔼 [ d ( X , Y ) ] \leq D , \\ {P}_{Y \vert X} is a valid conditional distribution . \qquad ( 2 )$$

This optimization problem is introduced in Fawaz, where it is shown to be a convex optimization. Therefore, the optimization problem can be solved by available convex solver or interior-point methods.

The minimum objective of Eq. (2) is denoted by L(D). A privacy preserving mapping is called (ε, D)—divergence-distortion private if its leakage factor and expected distortion are not greater than ε and D, respectively. Next, we provide an example of the optimization given in Eq. (2) and its solution.

### EXAMPLE 1

Assume S has a

$$Bern ( \frac{1}{2} )$$

distribution and X is the result of S passing through a BSC(p) channel (assume

$$p \leq \frac{1}{2} ) .$$

Assume the distortion measure is Hamming distortion, i.e., P[X≠Y]≦D. Note that using the kernel P_{Y|X} given by Y=X⊕Z, where Z has a Bern(D) distribution, we achieve I(S; Y)=1−h(p*D), where p*D=p(1−D)+(1−p)D and h(.) denote the entropy of a Bernoulli random variable. Next, we show that the minimum objective of Eq. (2) is 1−h(p* D). We have I(S;Y)=H(S)−H(S|Y)=1−H(S⊕Y|Y)≧131 H(S⊕Y). Using Markov property, it is straightforward to obtain P[S⊕Y=1]≦p(1−D)+(1−p)D. Therefore, the minimum objective of Eq. (2) is 1−h(p*D). Assume we want to have full privacy. Full privacy is not possible except in two cases:1)

$$p = \frac{1}{2} ,$$

implying X is independent from S. In this case, there is no privacy problem to begin with. 2)

$$D = \frac{1}{2} ,$$

implying Y is independent from X. In this case, full privacy implies no utility may be provided to a user for services received based on the released data.

One natural and related question is whether a privacy preserving mapping which is designed to minimize information leakage by solving the optimization problem as shown in Eq. (2), also provides guarantees on the probability of correctly inferring S from the observation of Y, using any inference algorithm. Next, we show a lower bound on the error probability in inferring S from Y, based on the information leakage, using any inference algorithm.

Proposition 1. Assume the cardinality of S, | [symbol] |>2 and I(S; Y)≦εH(S). Let Ŝ be an estimator of S based on the observation Y (possibly randomized). We have

$${P}_{e} = P [ \hat{S} ( Y ) \neq S ] \geq \frac{( 1 - ε ) H ( S ) - 1}{log ( \vert \vert - 1 )} . \qquad ( 3 )$$

For | [symbol] |=2, we have h(Pₑ)≧(1−ε)H(S).

Proof: From Fano's inequality, we have Pₑ(log(|S [symbol] |−1))≧H(S|Y)−h(Pₑ). Since I(Y;S)=H(S)−H(S|Y)≦εH(S), we have H(S|Y)≧(1−ε)H(S). Therefore,

$${P}_{e} \geq \frac{( 1 - ε ) H ( S ) - h ( {P}_{e} )}{log ( \vert \vert - 1 )} \geq \frac{( 1 - ε ) H ( S ) - 1}{log ( \vert \vert - 1 )} .$$

The proof when | [symbol] |=2 is similar. □

Thus, no matter the inference algorithm used by the analyst to infer S from the observation Y, the inference algorithm will incorrectly infer the private data as Ŝ(Y)≠S with probability at least

$$\frac{( 1 - ε ) H ( S ) - 1}{log ( \vert S \vert - 1 )} .$$

In other words, The success probability of any inference algorithm to correctly infer the private data as S is at most

$$1 - \frac{( 1 - ε ) H ( S ) - 1}{log ( \vert S \vert - 1 )} ,$$

which is bounded away from 1. The smaller ε, the higher the probability that the inference algorithm will be incorrect in the inference of the private data. In the extreme case where ε=0, perfect privacy is achieved, and no inference algorithm can perform better than an uninformed random guess.

### Joint Distribution P_{S,X} is Unknown

In practice, we may not have access to the joint probability distribution P_{S,X} Therefore, finding the exact optimal solution of the optimization problem (2) may not be possible. In particular, we may only know the probability measure, P_{X}, and not P_{S,X}. In this case, the privacy preserving mapping is the kernel P_{Y|X}, minimizing the following optimization problem

$${min}_{{P}_{Y \vert X}} {max }_{{P}_{S \vert X}} I ( S ; Y ) s . t . 𝔼 [ d ( X , Y ) ] \leq D , \\ {P}_{Y \vert X} is a valid conditional distribution . \qquad ( 4 )$$

In the following, we propose a scheme to achieve privacy (i.e., to minimize information leakage) subject to the distortion constraint, based on some techniques in statistical inference, called maximal correlation. We show how we can use this theory to design privacy preserving mappings without the full knowledge of the joint probability measure P_{S,X}. In particular, we prove a separability result on the information leakage: more precisely, we provide an upper bound on the information leakage in terms of I(S; X) times a maximal correlation factor, which is determined by the kernel, P_{Y|X}. This permits formulating the optimum mapping without the full knowledge of the joint probability measure P_{S,X}

Next, we provide a definition that is used in stating a decoupling result.
Definition 3. For a given joint distribution P_{X,Y}, let

$${S}^{*} ( X ; Y ) = {sup}_{r ( x ) \neq p ( x )} \frac{D ( r ( y ) ‖ p ( y ) )}{D ( r ( x ) ‖ p ( x ) )} ,$$

where r(y) is the marginal measure of p(y|x)r(x) on Y.

Note that S*(X; Y)≦1 because of data processing inequality for divergence. The following is a result of an article by V. Anantharam, A. Gohari, S. Kamath, and C. Nair, “On maximal correlation, hypercontractivity, and the data processing inequality studied by erkip and cover,” arXiv preprint arXiv:1304.6133, 2013 (hereinafter “Anantharam”).

Theorem 1. If S→X→Y form a Markov chain, the following bound holds:

I(S; Y)≦S*(X; Y)/(S; X), (6)

and the bound is tight as we vary S. In other words, we have

$${sup}_{S : S \to X \to Y} \frac{I ( S ; Y )}{I ( S ; X )} = {S}^{*} ( X ; Y ) , \qquad ( 7 )$$

assuming I(S; X)≠0.

Theorem 1 decouples the dependency of Y and S into two terms, one relating S and X, and one relating X and Y. Thus, one can upper bound the information leakage even without knowing P_{S,X}, by minimizing the term relating X and Y. The application of this result in our problem is described in the following.

Assume we are in a regime that P_{S,X} is not known and I(S; X)≦Δ for some Δ∈[0,H(S)]. I(S; X) is the intrinsic information embedded in X about S, which we do not have control on. The value of Δ does not affect the mapping we will find, but the value of Δ affects what we think is the privacy guarantee (in term of the leakage factor) resulting from this mapping. If the Δ bound is tight, then the privacy guarantee will be tight. If the Δ bound is not tight, we may then be paying more distortion than is actually necessary for a target leakage factor, but this does not affect the privacy guarantee.

Using Theorem 1, we have

$${min}_{{P}_{Y \vert X}} {max}_{{P}_{S . X}} I ( S ; Y ) = {min}_{{P}_{Y \vert X}} {max}_{{P}_{X}} {max}_{{P}_{S \vert X}} I ( S ; Y ) \leq Δ ( {min}_{{P}_{Y \vert X}} {max}_{{P}_{X}} {S}^{*} ( X ; Y ) ) . \qquad$$

Therefore, the optimization problem becomes to find P_{Y|X}, minimizing the following objective function:

$${min}_{{P}_{Y \vert X}} {max }_{{P}_{S \vert X}} {S}^{*} ( X ; Y ) s . t . 𝔼 [ d ( X , Y ) ] \leq D . \qquad ( 8 )$$

In order to study this optimization problem in more detail, we review some results in maximal correlation literature. Maximal correlation (or Rényi correlation) is a measure of correlation between two random variables with applications both in information theory and computer science. In the following, we define maximal correlation and provide its relation with S*(X; Y).

Definition 4. Given two random variables X and Y, the maximal correlation of (X, Y) is

$${ρ}_{m} ( X ; Y ) = {max}_{( f ( X ) , g ( Y ) ) ∈ 𝒥} 𝔼 [ f ( X ) g ( Y ) ] , \qquad ( 9 )$$

where [symbol] is the collection of pairs of real-valued random variables f(X) and g(Y) such that [symbol] [f(X)]= [symbol] [g(Y)]=0 and [symbol] [f(X)²]= [symbol] [g(Y)²]=1.

This measure was first introduced by Hirschfeld (H. O. Hirschfeld, “A connection between correlation and contingency,” in Proceedings of the Cambridge Philosophical Society, vol. 31) and Gebelein (H. Gebelein, “Das statistische Problem der Korrelation als Variations—und Eigenwert—problem und sein Zusammenhang mit der Ausgleichungsrechnung,” Zeitschrift fur angew. Math. und Mech. 21, pp. 364-379 (1941)), and then studied by Rényi (A. Rényi, “On measures of dependence,” Acta Mathematica Hungarica, vol. 10, no. 3). Recently, Anantharam et al. and Kamath et al. (S. Kamath and V. Anantharam, “Non-interactive simulation of joint distributions: The hirschfeld-gebelein-rényi maximal correlation and the hypercontractivity ribbon,” in Communication, Control, and Computing (Allerton), 2012 50th Annual Allerton Conference on, hereinafter “Kamath”) studied the maximal correlation and provided a geometric interpretation of this quantity. The following is a result of an article by R. Ahlswede and P. Gács, “Spreading of sets in product spaces and hypercontraction of the markov operator,” The Annals of Probability (hereinafter “Ahlswede”):

$${max}_{{P}_{X}} {ρ}_{m}^{2} ( X ; Y ) = {max}_{{P}_{X}} {S}^{*} ( X ; Y ) . \qquad ( 10 )$$

Substituting (10) in (8), the privacy preserving mapping is the solution of

$${min}_{{P}_{Y \vert X}} {max }_{{P}_{X}} {ρ}_{m}^{2} ( X ; Y ) s . t . 𝔼 [ d ( X , Y ) ] \leq D . \qquad ( 11 )$$

It is shown in an article by H. S. Witsenhausen, “On sequences of pairs of dependent random variables,” SIAM Journal on Applied Mathematics, vol. 28, no. 1 that, maximal correlation, ρₘ(X;Y) is characterized by the second largest singular value of the matrix Q with entries

$${Q}_{x , y} = \frac{P ( x , y )}{\sqrt{P ( x ) P ( y )}} .$$

The optimization problem can be solved by power iteration algorithm or Lanczos algorithm for finding singular values of a matrix.

The two quantities S*(X; Y) and ρₘ²(X; Y) are closely related. Two sufficient conditions under which S*(X; Y)=ρₘ²(X;Y) are given in Theorem 7 of Ahlswede. Next, we provide an example of such case.

### EXAMPLE 2

$$Let X \sim Bern ( \frac{1}{2} )$$

and Y=X+N (mod 2), where N˜Bern(D) and X is independent of N(X [symbol] N). It is shown in Kamath that, S*(X; Y)=ρₘ²(X;Y)=(1−2D)². Using this bound where

$$S \sim Bern ( \frac{1}{2} )$$

X=S+Bern(p), and Y=X+Bern(D), we obtain I(S; Y)≦(1−2D)²(1−h(p)). Compare this to what we showed in Example 1: I(S; Y)=1−h(p*D). Here, (1−2D)² is the injected privacy term obtained by the kernel P_{Y|X} and 1−h(p) is the intrinsic information/privacy term, quantifying the relation between X and S.
Marginal Distribution P_{X} is Known, but not the Joint Distribution P_{S,X}

Next, we consider the case where only the marginal distribution P_{X} is known but not the joint distribution P_{S,X}. We wish to design P_{Y|X}. Assume that, |X|=| [symbol] |=n. The optimization problem in Eq. (8) becomes

$${min}_{{P}_{Y \vert X}} {S}^{*} ( X ; Y ) s . t . 𝔼 [ d ( X ; Y ) ] \leq D . \qquad ( 12 )$$

Now, consider the following optimization problem by replacing S*(X; Y) with ρₘ²ⁱ(X; Y).

$${min}_{{P}_{Y \vert X}} {ρ}_{m}^{2} ( X ; Y ) s . t . 𝔼 [ d ( X ; Y ) ] \leq D . \qquad ( 13 )$$

We solve this optimization problem and if the final solution satisfies S*(X; Y)=ρₘ²(X; Y), then we have the solution to (12). In particular, if one of the conditions given in Ahlswede holds, then we have the solution to (12). Next, we reformulate the constraint set in (13).

Theorem 2. Given a distribution P_{X}, let \sqrt{P_{X}} denote a vector with entries equal to square root of entries of P_{X}. If Q is a n×n matrix satisfying the following constraints: 1) Q≧0 (entry-wise), 2) ∥Q^{t}\sqrt{P_{X}}∥₂=1, and 3) Q Q^{t}\sqrt{P_{X}}=\sqrt{P_{X}}, then P_{Y|X}(and P_{X,Y}) can be found uniquely such that

$${Q}_{x , y} = \frac{P ( x , y )}{\sqrt{P ( x )} \sqrt{P ( y )}} ,$$

Proof: Since Q≧0 and \sqrt{P_{X}}≧0, we have Q^{t}\sqrt{P_{X}}≧0. On the other hand since we have ∥Q^{t}\sqrt{P_{X}}∥₂=1, Q^{t}\sqrt{P_{X}} form square root of a probability distribution denoted by \sqrt{P_{Y}}. Let P_{X,Y}(i, j)=Q(i, j)\sqrt{P_{X}(i)}\sqrt{P_{Y}(j)}. We claim that this P_{XY} is a joint probability distribution consistent with P_{X} and P_{Y}. Using the assumptions, we have Σ_{i,j}P_{X,Y}(i,j)=Σⱼ\sqrt{P_{Y}(j)}Σᵢ(i,j)\sqrt{P_{X}(i)}=1. Therefore, the defined P_{X,Y} is a probability measure (using assumption 1, the entries are non-negative). Next, we show that P_{X,Y} is consistent with P_{Y}. We have ΣᵢP_{X,Y}(i,j)=\sqrt{P_{Y}(j)}(ΣᵢQ(i, j)\sqrt{P_{X}(i)})=P_{Y}(j). Similarly, P_{X,Y} is consistent with P_{X}. □

Theorem 2 shows that we can rewrite the optimization problem (13) as

min λ₂(Q)

Q:QQ^{t}\sqrt{P_{X}}=\sqrt{P_{X,}}∥Q^{t}\sqrt{P_{X}}∥₂=1

[symbol]

d(X; Y)]≦D, Q≧0(entry-wise), (14)

where λ₂(Q) denotes the second largest singular value of Q and expectation is over the joint probability induced by matrix Q. Note that the constraints are quadratic in the entries of Q. As an example of distortion constraint, [symbol] [X=Y]=tr( [symbol] (\sqrt{P_{X}})Q [symbol] (Q^{t}\sqrt{P_{X}}))≧1−D is quadratic in Q, where [symbol] (ν) is a diagonal matrix with entries of v on the diagonal. Once we find Q, then we obtain P_{Y|X}. Again, this optimization can be solved by power iteration algorithm or Lanczos algorithm.

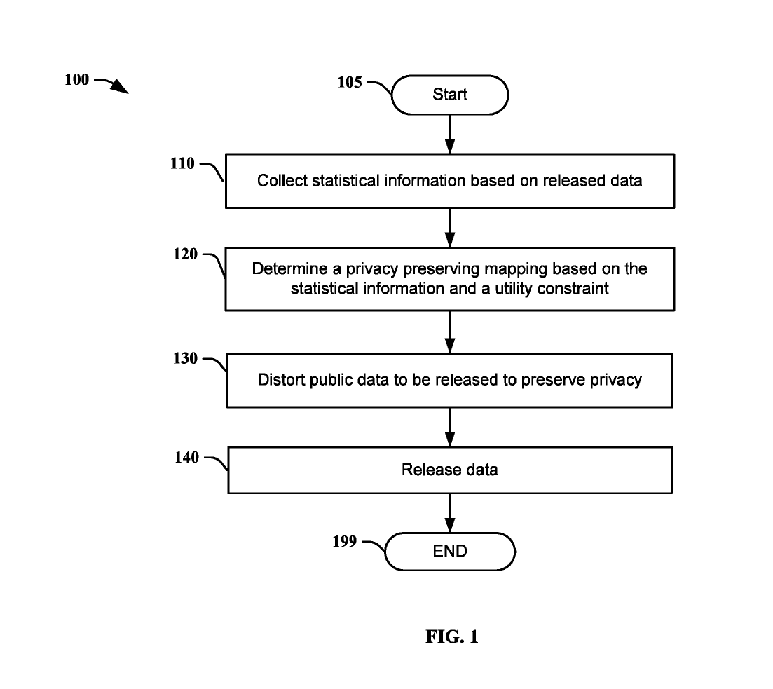

FIG. 1 illustrates an exemplary method 100 for distorting public data to be released in order to preserve privacy according to the present principles. Method 100 starts at 105. At step 110, it collects statistical information based on released data, for example, from the users who are not concerned about privacy of their public data or private data. We denote these users as “public users,” and denote the users who wish to distort public data to be released as “private users.”

The statistics may be collected by crawling the web, accessing different databases, or may be provided by a data aggregator, for example, by bluekai.com. Which statistical information can be gathered depends on what the public users release. For example, if the public users release both private data and public data, an estimate of the joint distribution P_{S,X} can be obtained. In another example, if the public users only release public data, an estimate of the marginal probability measure P_{X} can be obtained, but not the joint distribution P_{S,X}. In another example, we may only be able to get the mean and variance of the public data. In the worst case, we may be unable to get any information about the public data or private data.

At step 120, it determines a privacy preserving mapping based on the statistical information given the utility constraint. As discussed before, the solution to the privacy preserving mapping mechanism depends on the available statistical information. For example, if the joint distribution P_{S,X} is known, the privacy preserving mapping may be obtained using Eq. (2); if the marginal distribution P_{X} is known, but not the joint distribution P_{S,X}, the privacy preserving mapping may be obtained using Eq. (4); if neither the marginal distribution P_{X} nor joint distribution P_{S,X} is known, the privacy preserving mapping P_{Y|X} may be obtained using Eq. (8).

At step 130, the public data of a current private user is distorted, according to the determined privacy preserving mapping, before it is released to, for example, a service provider or a data collecting agency, at step 140. Given the value X=x for the private user, a value Y=y is sampled according to the distribution P_{Y|X=x}. This value y is released instead of the true x. Note that the use of the privacy mapping to generate the released y does not require knowing the value of the private data S=s of the private user. Method 100 ends at step 199.

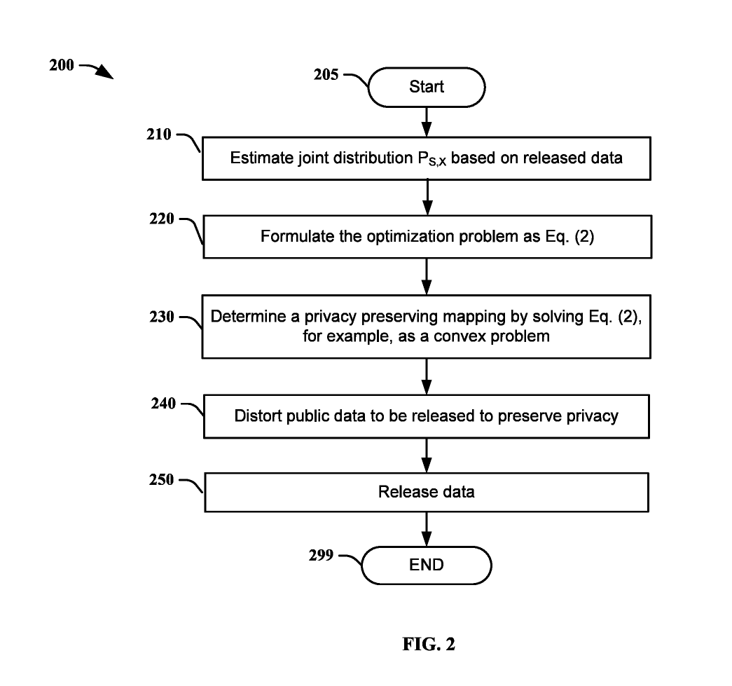

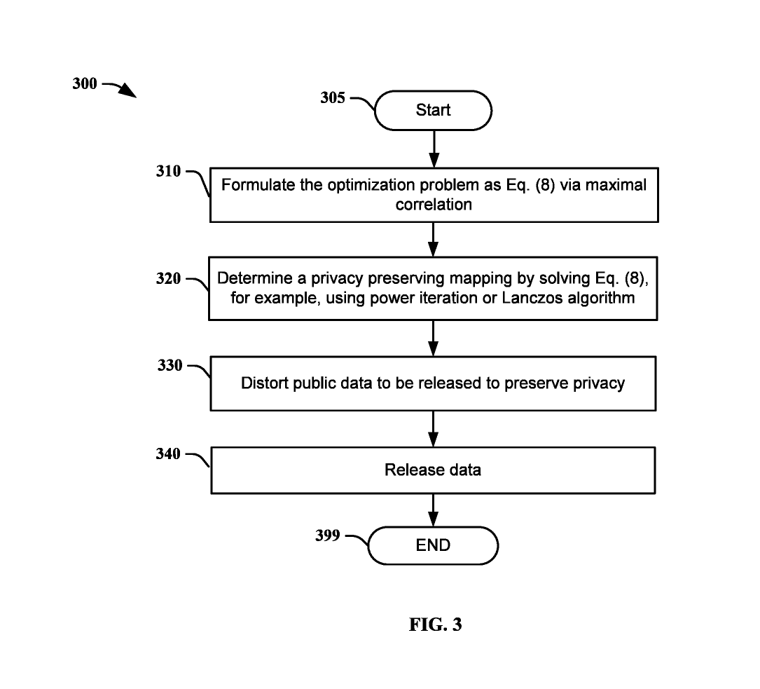

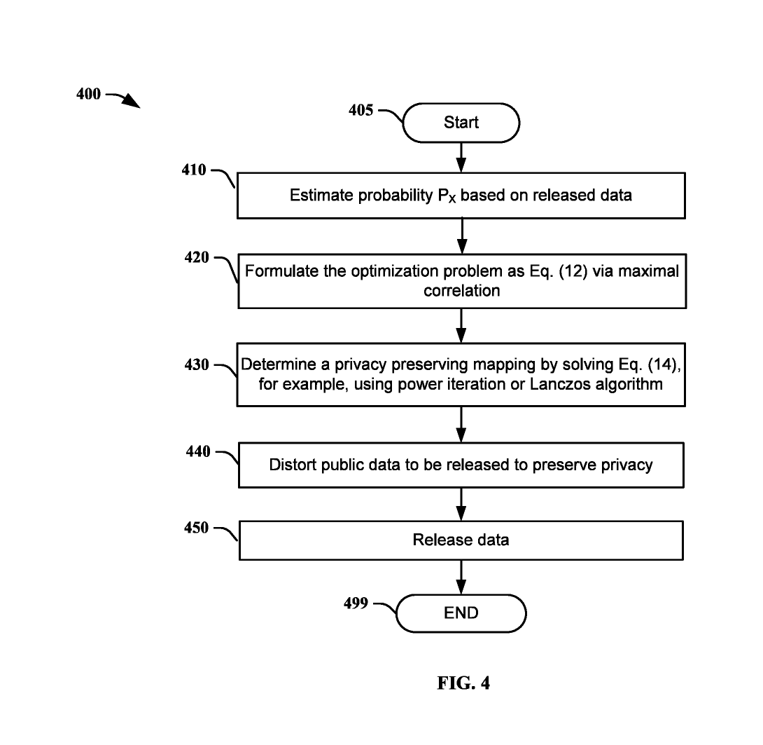

FIGS. 2-4 illustrate in further detail exemplary methods for preserving privacy when different statistical information is available. Specifically, FIG. 2 illustrates an exemplary method 200 when the joint distribution P_{S,X} is known, FIG. 3 illustrates an exemplary method 300 when the marginal probability measure P_{X} is known, but not joint distribution P_{S,X}, and FIG. 4 illustrates an exemplary method 400 when neither the marginal probability measure P_{X} nor joint distribution P_{S,X} is known. Methods 200, 300 and 400 are discussed in further detail below.

Method 200 starts at 205. At step 210, it estimates joint distribution P_{S,X} based on released data. At step 220, it formulates the optimization problem as Eq. (2). At step 230, it determines a privacy preserving mapping based on Eq. (2), for example, solving Eq. (2) as a convex problem. At step 240, the public data of a current user is distorted, according to the determined privacy preserving mapping, before it is released at step 250. Method 200 ends at step 299.

Method 300 starts at 305. At step 310, it formulates the optimization problem as Eq. (8) via maximal correlation. At step 320, it determines a privacy preserving mapping based on Eq. (8), for example, solving Eq. (8) using power iteration or Lanczos algorithm. At step 330, the public data of a current user is distorted, according to the determined privacy preserving mapping, before it is released at step 340. Method 300 ends at step 399.

Method 400 starts at 405. At step 410, it estimates distribution P_{X} based on released data. At step 420, it formulates the optimization problem as Eq. (4) via maximal correlation. At step 430, it determines a privacy preserving mapping based on Eq. (12), for example, by solving the related Eq. (14) using power iteration or Lanczos algorithm. At step 440, the public data of a current user is distorted, according to the determined privacy preserving mapping, before it is released at step 450. Method 400 ends at step 499.

A privacy agent is an entity that provides privacy service to a user. A privacy agent may perform any of the following:

receive from the user what data he deems private, what data he deems public, and what level of privacy he wants;

compute the privacy preserving mapping;

implement the privacy preserving mapping for the user (i.e., distort his data according to the mapping); and

release the distorted data, for example, to a service provider or a data collecting agency.

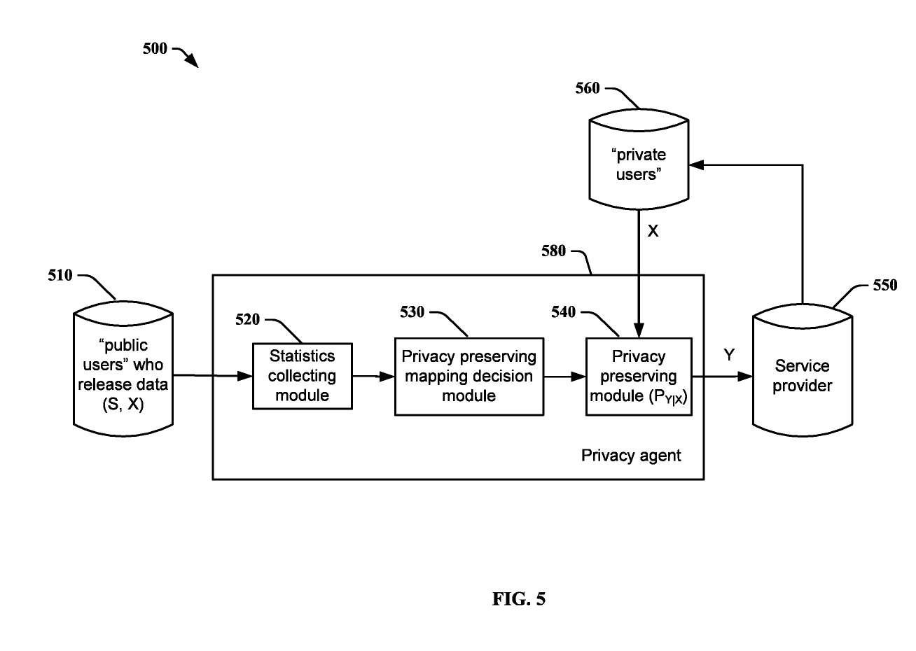

The present principles can be used in a privacy agent that protects the privacy of user data. FIG. 5 depicts a block diagram of an exemplary system 500 where a privacy agent can be used. Public users 510 release their private data (S) and/or public data (X). As discussed before, public users may release public data as is, that is, Y=X. The information released by the public users becomes statistical information useful for a privacy agent.

A privacy agent 580 includes statistics collecting module 520, privacy preserving mapping decision module 530, and privacy preserving module 540. Statistics collecting module 520 may be used to collect joint distribution P_{S,X}, marginal probability measure P_{X}, and/or mean and covariance of public data. Statistics collecting module 520 may also receive statistics from data aggregators, such as bluekai.com. Depending on the available statistical information, privacy preserving mapping decision module 530 designs a privacy preserving mapping mechanism P_{Y|X}, for example, based on the optimization problem formulated as Eq. (2), (8), or (12). Privacy preserving module 540 distorts public data of private user 560 before it is released, according to the conditional probability P_{Y|X}. In one embodiment, statistics collecting module 520, privacy preserving mapping decision module 530, and privacy preserving module 540 can be used to perform steps 110, 120, and 130 in method 100, respectively.

Note that the privacy agent needs only the statistics to work without the knowledge of the entire data that was collected in the data collection module. Thus, in another embodiment, the data collection module could be a standalone module that collects data and then computes statistics, and needs not be part of the privacy agent. The data collection module shares the statistics with the privacy agent.

A privacy agent sits between a user and a receiver of the user data (for example, a service provider). For example, a privacy agent may be located at a user device, for example, a computer, or a set-top box (STB). In another example, a privacy agent may be a separate entity.

All the modules of a privacy agent may be located at one device, or may be distributed over different devices, for example, statistics collecting module 520 may be located at a data aggregator who only releases statistics to the module 530, the privacy preserving mapping decision module 530, may be located at a “privacy service provider” or at the user end on the user device connected to a module 520, and the privacy preserving module 540 may be located at a privacy service provider, who then acts as an intermediary between the user, and the service provider to whom the user would like to release data, or at the user end on the user device.

The privacy agent may provide released data to a service provider, for example, Comcast or Netflix, in order for private user 560 to improve received service based on the released data, for example, a recommendation system provides movie recommendations to a user based on its released movies rankings.

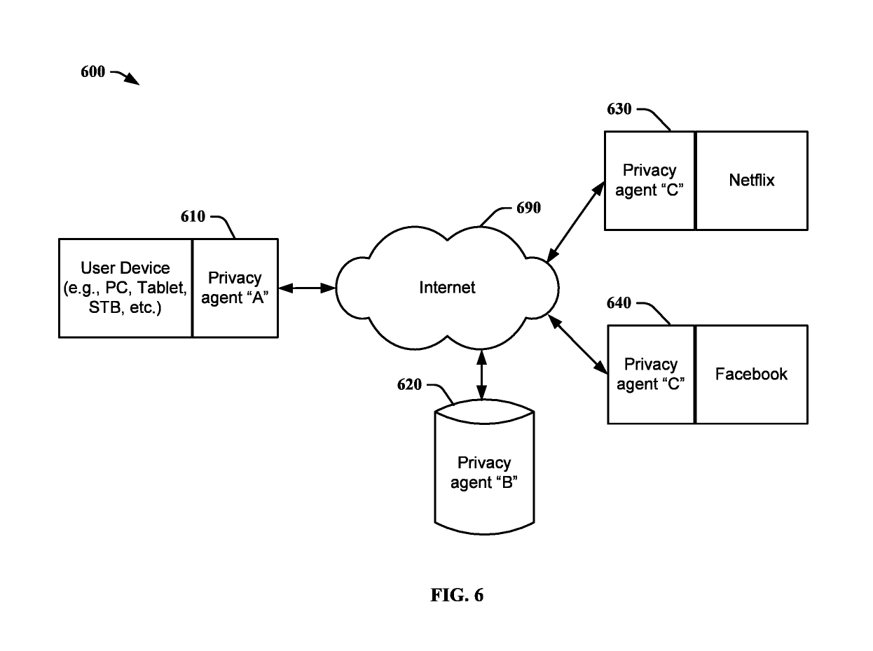

In FIG. 6, we show that there are multiple privacy agents in the system. In different variations, there need not be privacy agents everywhere as it is not a requirement for the privacy system to work. For example, there could be only a privacy agent at the user device, or at the service provider, or at both. In FIG. 6, we show that the same privacy agent “C” for both Netflix and Facebook. In another embodiment, the privacy agents at Facebook and Netflix, can, but need not, be the same.

In the following, we compare and show the relationship between different existing privacy metrics, in particular divergence privacy, differential privacy, and information privacy. We provide examples on the differences in the privacy-accuracy tradeoffs achieved under these different notions. We show that using divergence privacy, the present principles advantageously guarantee a small probability of inferring private data based on the released data (Proposition 1).

### Definition 5.

Differential privacy: For a given ε, P_{Y|S} is ε—differentially private if

$${sup}_{y , s , {s}^{′} \text{:} s \sim {s}^{′}} \frac{P ( y ∈ A \vert s )}{P ( y ∈ A \vert {s}^{′} )} \leq {e}^{ε} , \qquad ( 15 )$$

for any measurable set A, where s˜s′ denotes that, s and s′ are neighbors. The notion of neighboring can have multiple definitions, e.g., Hamming distance 1 (differ in a single coordinate), or lₚ distance below a threshold. In the present application, we use the former definition.

Strong differential privacy: For a given ε, P_{Y|S} is ε—strongly differential private if

$${sup}_{y , s , {s}^{′}} \frac{P ( y ∈ A \vert s )}{P ( y ∈ A \vert {s}^{′} )} \leq {e}^{ε} , \qquad ( 16 )$$

for any measurable set A and s and s′. This definition is related to local differential privacy. This is stronger than differential privacy, because we relaxed the neighboring assumption.

Information privacy: For a given ε, P_{Y|S} is ε—information private if

$${e}^{- ε} \leq \frac{P ( s ∈ B \vert y ∈ A )}{P ( s ∈ B )} \leq {e}^{ε} , \qquad ( 17 )$$

for any measurable sets A and B.

Worst-case divergence privacy: For a given ε, P_{Y|S} is worst-case ε—divergence private if

$$H ( S ) = {min}_{y} H ( S \vert Y = y ) = ε H ( S ) \qquad ( 18 )$$

(ε, δ)—differential privacy: For any given ε and δ, P_{Y|S} is (ε, δ) differentially private if

P(yεA|s)≦P(yΕA|s′)e^{ε}+δ, (19)

for any measurable set A and neighboring s and s′.

Next, we compare the definitions given above.

Proposition 2. We have the following relation between the privacy metrics, where “ [symbol] ” means “imply,” that is, it means that the right side follows form the left side.
ε—strong differential privacy [symbol] ε—information privacy
ε—information privacy [symbol] 2ε—strong differential privacy
ε—information privacy

$$⇒ \frac{ε}{H ( S )}$$

—worst-case aivergence privacy

$$\frac{ε}{H ( S )}$$

—worst-case aivergence privacy

$$⇒ \frac{ε}{H ( S )}$$

—divergence privacy
ε—differential privacy [symbol] (ε, δ)—differential privacy for any δ≧0.

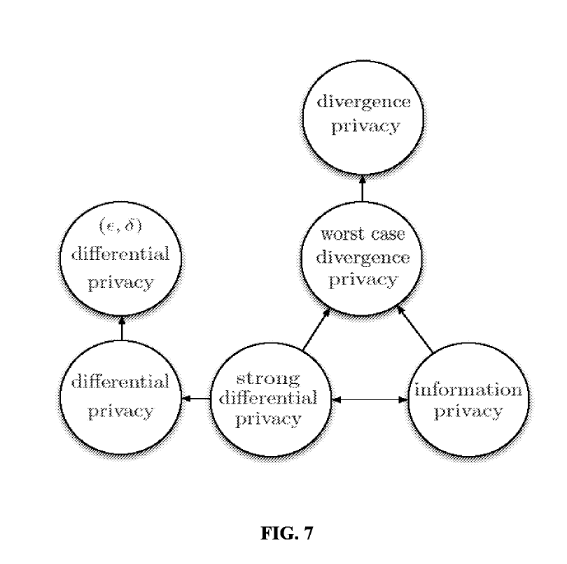

Proposition 2 is summarized in FIG. 7. In the following, we give two examples comparing differential privacy with divergence privacy. In the first example, we focus on the probability of recovering the private data given that we satisfy these notions of privacy.

Considering the particular case of counting query, we show that, using differential privacy, full detection of the private data is possible. On the other hand, using divergence privacy, the probability of detecting the private data is small.

### EXAMPLE 3

Let S₁, . . . , Sₙ be binary correlated random variables and let X=Σᵢ₌₁ⁿSᵢ, Assume S₁, . . . , Sₙ are correlated in a way that, S₁≧ . . . ≧Sₙ. Therefore, knowing X, we can exactly recover S=(S₁, . . . , Sₙ). Also, assume Sᵢs (1≦i≦n) are correlated in a way that

$$P ( X = ki ) = \frac{1}{1 + n / k} ,$$

for i∈{0,1, . . . , n/k} (assume, n=0 mode k). P(Y|S) is ε—differentially private if we add Laplacian noise to X, i.e.,

$$Y = X + Lap ( \frac{1}{ε} ) .$$

Fix ε and let n=k^{k}, where k goes to infinity. It is shown that error probability in detecting
X (and S) is approximately

$${P}_{e} = {e}^{\frac{- k ε}{2}} ,$$

which is very small for large enough k. Thus, differential privacy does not guarantee a small probability of detecting S. Note that, the divergence privacy factor is approximately

$$\frac{I ( S ; Y )}{H ( S )} = 1 - {e}^{\frac{- k ε}{2}} ,$$

which is very close to one and this is the reason for large detection probability. P(Y|S) is ε—divergence private if we add Gaussian noise instead of Laplacian noise, with a variance chosen appropriately as follows. The variance of the Gaussian noise depends on the correlation in the data S via the variance of X, σ_{X}². We have

$${σ}_{X}^{2} \approx \frac{1}{12} {k}^{2 k} ,$$

where ≈ denotes that, the ratio goes to 1 as k goes to infinity. Let N be a Gaussian distribution with a variance satisfying:

$$\frac{{σ}_{X}^{2}}{{σ}_{N}^{2}} \approx {k}^{2 ε ( k - 1 )} .$$

Adding this noise to X, the leakage factor is less than or equal to ε. Moreover,

$${P}_{e} \geq \frac{( 1 - ε ) log ( 1 + n / k )}{log n} {\to }^{k \to ∞} 1 - ε .$$

That is, the probability of detecting private data is very small using divergence privacy.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

Additionally, this application or its claims may refer to “determining” various pieces of information. Determining the information may include one or more of, for example, estimating the information, calculating the information, predicting the information, or retrieving the information from memory.

Further, this application or its claims may refer to “accessing” various pieces of information. Accessing the information may include one or more of, for example, receiving the information, retrieving the information (for example, from memory), storing the information, processing the information, transmitting the information, moving the information, copying the information, erasing the information, calculating the information, determining the information, predicting the information, or estimating the information.

Additionally, this application or its claims may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

As will be evident to one of skill in the art, implementations may produce a variety of signals formatted to carry information that may be, for example, stored or lo transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method for processing user data for a user, comprising:
accessing the user data, which includes private data and public data, the private data corresponding to a first category of data, and the public data corresponding to a second category of data;
decoupling dependencies between the first category of data and the second category of data, from dependencies between the second category of data and released data;
determining a privacy preserving mapping that maps the second category of data to the released data responsive the dependencies between the second category of data and the released data;
modifying the public data for the user based on the privacy preserving mapping; and
releasing the modified data to at least one of a service provider and a data collecting agency.

2. The method of claim 1, wherein the public data comprises data that the user has indicated can be publicly released, and the private data comprises data that the user has indicated is not to be publicly released.

3. The method of claim 1, further comprising the step of:
determining the dependencies between the first category of data and the second category of data responsive to mutual information between the first category of data and the second category of data.

4. The method of claim 1, wherein the steps of decoupling and determining a privacy preserving mapping are based on maximal correlation techniques.

5. The method of claim 1, further comprising the step of:
accessing a constraint on utility, the utility being responsive to the second category of data and the released data, wherein the step of determining a privacy preserving mapping is further responsive to the utility constraint.

6. The method of claim 1, wherein the determining a privacy preserving mapping comprises:
minimizing the maximum information leakage between the first category of data and the released data.

7. The method of claim 1, further comprising the step of:
accessing statistical information based on the second category of data from other users, wherein the statistical information is used to determine the privacy preserving mapping.

8. The method of claim 7, wherein the step of determining comprises determining independently of a joint distribution between the first category of data and the second category of data.

9. The method of claim 7, wherein the step of determining comprises determining independently of a marginal distribution of the second category of data.

10. The method of claim 1, further comprising the step of receiving service based on the released distorted data.

11. An apparatus for processing user data for a user, comprising:
a processor configured to access the user data, which includes private data and public data, the private data corresponding to a first category of data, and the public data corresponding to a second category of data
a privacy preserving mapping decision module coupled to the processor and configured to
decouple dependencies between the first category of data and the second category of data, from dependencies between the second category of data and released data, and
determine a privacy preserving mapping that maps the second category of data to the released data responsive the dependencies between the second category of data and released data;
a privacy preserving module configured to
modify the public data for the user based on the privacy preserving mapping, and
release the modified data to at least one of a service provider and a data collecting agency.

12. The apparatus of claim 11, wherein the public data comprises data that the user has indicated can be publicly released, and the private data comprises data that the user has indicated is not to be publicly released.

13. The apparatus of claim 11, wherein the privacy preserving mapping decision module determines the dependencies between the first category of data and the second category of data responsive to mutual information between the first category of data and the second category of data.

14. The apparatus of claim 11, wherein the privacy preserving mapping decision module decouple dependencies and determines a privacy preserving mapping based on maximal correlation techniques.

15. The apparatus of claim 11, wherein the privacy preserving mapping decision module accesses a constraint on utility, the utility being responsive to the second category of data and the released data, and determines the privacy preserving mapping responsive to the utility constraint.

16. The apparatus of claim 11, wherein the privacy preserving mapping decision module minimizes the maximum information leakage between the first category of data and the released data.

17. The apparatus of claim 11, wherein the privacy preserving mapping decision module accesses statistical information based on the second category of data from other users, wherein the statistical information is used to determine the privacy preserving mapping.

18. The apparatus of claim 17, wherein the privacy preserving mapping decision module determines the privacy preserving mapping independently of a joint distribution between the first category of data and the second category of data.

19. The method of claim 17, wherein the privacy preserving mapping decision module determines the privacy preserving mapping independently of a marginal distribution of the second category of data.

20. The apparatus of claim 11, further comprising a processor configured to receive service based on the released distorted data.

21. (canceled)
